(19) United States
(12) Patent Application Publication
(10) Pub. No.: US 2017/0312562 A1
(43) Pub. Date: Nov. 2, 2017

(54) FIRE SUPPRESSION SYSTEM AND METHOD

(71) Applicant: Carrier Corporation, Farmington, CT (US)

(72) Inventors: Robert A. Chopko, Baldwinsville, NY (US); Joseph Senecal, Wellesley, MA (US); Treese Hugener-Campbell, Coventry, CT (US)

(21) Appl. No.: 15/518,409

(22) PCT Filed: Oct. 5, 2015
(86) PCT No.: PCT/US15/53944

§ 371 Date: Apr. 11, 2017

Related U.S. Application Data
(60) Provisional application No. 62/064,757, filed on Oct. 16, 2014.

(51) Int. Cl. A62C 35/10; A62C 3/00; A62C 3/07; A62C 99/00

(52) U.S. Cl. CPC A62C 35/10; A62C 99/0045; A62C 3/002; A62C 3/07

(57) ABSTRACT

A fire suppression system includes a transport refrigeration unit configured to cool a transport container. Also included is a tubular container having a fire suppressant stored therein, the tubular container disposed within the transport refrigeration unit. Further included is a predetermined fracture location of the tubular container, wherein the predetermined fracture location is configured to rupture upon reaching a critical temperature to expel the fire suppressant.

### BACKGROUND OF THE INVENTION

The embodiments herein generally relate to fire suppression systems and, more particularly, to a fire suppression system located on-board a transport refrigeration unit, as well as a method of suppressing a fire within such a transport refrigeration unit.

Fire suppression systems are generally known for fighting a fire in a building or other large stationary structure, however, such systems are not readily available for mobile units, such that vehicles or other mobile transport units are not typically equipped with on-board fire suppression systems. For example, a transport refrigeration unit used for cooling a volume does not include a fire suppression system that is integrated therein. Transport refrigeration units include engine compartments that operate at elevated temperatures and include components that may be susceptible to a thermal event. The use of fuel, grease and electrical components inherently pose thermal event risks that must be addressed. Although a mobile structure may have fire suppression capabilities, it would be beneficial to quickly contain and extinguish a fire within at its origin (e.g., engine compartment) to minimize damage to the engine compartment and to the overall surrounding structure of the transport refrigeration unit.

### BRIEF DESCRIPTION OF THE INVENTION

According to one embodiment, a fire suppression system includes a transport refrigeration unit configured to cool a transport container. Also included is a tubular container having a fire suppressant stored therein, the tubular container disposed within the transport refrigeration unit. Further included is a predetermined fracture location of the tubular container, wherein the predetermined fracture location is configured to rupture upon reaching a critical temperature to expel the fire suppressant.

In addition to one or more of the features described above, or as an alternative, further embodiments may include that the tubular container comprises a plastic material.

In addition to one or more of the features described above, or as an alternative, further embodiments may include that the predetermined fracture location comprises an elongated fracture line extending along a longitudinal direction of the tubular container.

In addition to one or more of the features described above, or as an alternative, further embodiments may include that the elongated fracture line extends along a majority of the tubular container along the longitudinal direction.

In addition to one or more of the features described above, or as an alternative, further embodiments may include that the tubular container comprises a plurality of predetermined fracture locations configured to rupture upon reaching the critical temperature to expel the fire suppressant.

In addition to one or more of the features described above, or as an alternative, further embodiments may include that the plurality of predetermined fracture locations are each located adjacent components of an engine compartment of the transport refrigeration unit susceptible to a thermal event.

In addition to one or more of the features described above, or as an alternative, further embodiments may include that the thermal event comprises at least one of an electrical fire, a grease fire, a flammable metal fire, and a fuel fire.

In addition to one or more of the features described above, or as an alternative, further embodiments may include that the fire suppressant comprises at least one of mono-ammonium phosphate powder, potassium carbonate-based powder, sodium bicarbonate-based powder, and potassium allophanate.

In addition to one or more of the features described above, or as an alternative, further embodiments may include that the tubular container is located proximate an upper portion of an engine compartment of the transport refrigeration unit.

In addition to one or more of the features described above, or as an alternative, further embodiments may include that the tubular container is pressurized.

In addition to one or more of the features described above, or as an alternative, further embodiments may include that the tubular container is pressurized to a pressure ranging from 3 psia to 5 psia.

According to another embodiment, a method of suppressing a fire within a refrigeration transport unit is provided. The method includes providing a predetermined fracture location along a portion of a tubular container configured to contain a fire suppressant therein. The method also includes positioning the tubular container proximate an engine compartment of the refrigeration transport unit. The method further includes rupturing the tubular container along the predetermined fracture location upon detection of a critical temperature within the engine compartment. The method yet further includes expelling the fire suppressant from the tubular container.

In addition to one or more of the features described above, or as an alternative, further embodiments may include that providing the predetermined fracture location comprises perforating the tubular container along a longitudinal direction of the tubular container.

In addition to one or more of the features described above, or as an alternative, further embodiments may include that the fire suppressant configured to be contained comprises at least one of mono-ammonium phosphate powder, potassium carbonate-based powder, sodium bicarbonate-based powder, and potassium allophanate.

In addition to one or more of the features described above, or as an alternative, further embodiments may include that positioning the tubular container comprises positioning the tubular container proximate an upper portion of the engine compartment.

In addition to one or more of the features described above, or as an alternative, further embodiments may include pressurizing the tubular container.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a transport refrigeration unit having fire suppression system located proximate an engine compartment;

FIG. 2 is a cross-sectional view of a tubular container of the fire suppression system; and

FIG. 3 is an enlarged view of section III of FIG. 2 illustrating a predetermined fraction location of the tubular container.

### DETAILED DESCRIPTION OF THE INVENTION

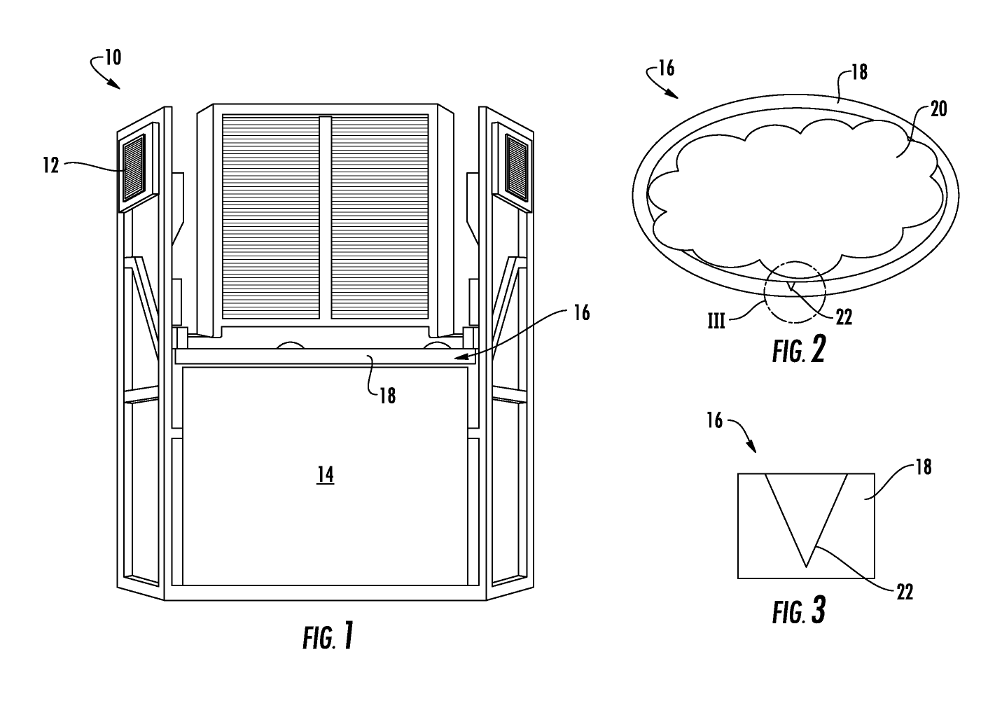

Referring to FIG. 1, a transport refrigeration unit is illustrated and generally referred to with numeral 10. The transport refrigeration unit 10 may be located on-board trailers and other mobile containers in order to control the environment within such mobile containers. For example, it is often desirable to control the temperature and or humidity within a container. It may also be advantageous to provide for circulation of the air within a container, to exchange air within a container with ambient air from outside, or to introduce other gases such as ozone, carbon dioxide, or nitrogen into a shipping container so as to maintain a desired environment within the container. Regardless of the particular type of mobile unit that the transport refrigeration unit 10 is employed with, it is to be understood that the transport refrigeration unit 10 is configured to condition (e.g., cool) the environment of a transport container.

The transport refrigeration unit 10 comprises various components and sections that are typically located within a housing 12. The components located therein are known refrigeration components, such as an engine, a compressor, and a generator, for example. The particular types of components may vary depending upon the particular type of transport refrigeration unit. For example, the engine may be a diesel or gasoline engine. As noted above, refrigeration components are known in the art and the embodiments of the invention described herein do not require extensive description related to the refrigeration components. These components are typically housed in close proximity and operatively coupled to each other. As generally shown, the transport refrigeration unit 10 includes an engine compartment 14 configured to contain the engine and possibly various other components.

A fire suppression system 16 is provided to quickly contain and extinguish a thermal event associated with the transport refrigeration unit 10. In particular, the fire suppression system 16 is focused on containment and extinguishing of fires within regions of the transport refrigeration unit 10 that may be susceptible to a thermal event. In some embodiments, this region is the engine compartment 14. Various types of thermal events are known, such as electrical fires, grease fires, flammable metal fire and fuel fires, for example. Although the fire suppression system 16 is described herein as being located proximate or within the engine compartment 14, it is to be appreciated that the fire suppression system 16 may be located at other regions of the transport refrigeration unit 10.

The fire suppression system 16 includes a tubular container 18 that extends throughout a portion of the engine compartment 14. Positioning of the tubular container 18 will vary depending upon the particular application, however, the tubular container 18 is strategically positioned based on historical analysis of thermal events within the engine compartment 14 to most efficiently contain and extinguish a fire. In one embodiment, the tubular container 18 is located proximate an upper portion of the engine compartment 14 in order to allow gravity to assist in directing a fire suppressant throughout the engine compartment.

Referring now to FIGS. 2 and 3, with continued reference to FIG. 1, the tubular container 18 is illustrated in greater detail as a cross-sectional view. Although the tubular container 18 is referred to as “tubular,” it is to be appreciated that alternative geometries may be employed. Specifically, the tubular container 18 must simply be configured to contain a fire suppressant 20 within an interior volume of the tubular container 18. The specific material of the tubular container 18 may vary depending on the particular application and operating environment. Exemplary materials include polypropylene, polyvinyl chloride, polyethylene and layers of these materials. The fire suppressant 20 stored therein may be any composition suitable for extinguishing a fire. In some embodiments, the fire suppressant 20 is a dry chemical composition, such as a powder. For example, the fire suppressant 20 is selected from the group of mono-ammonium phosphate powder, potassium carbonate-based powder, sodium bicarbonate-based powder, and potassium allophanate, sodium chloride, copper powder, graphite, sodium carbonate, sand, or powder formulations containing any of the above-noted powders. The precise amount of the fire suppressant 20 that is stored within the tubular container 18 may vary and will depend upon the particular size of the engine compartment 14 to be protected. In one embodiment, the amount of fire suppressant 20 stored therein is about four to about five times the amount that is required for the particular volume of the engine compartment 14.

The tubular container 18 may be formed of numerous contemplated materials, such as plastic, for example. A predetermined fracture location 22 is provided at one or more locations along the tubular container 18. The predetermined fracture location 22 is a portion of the tubular container 18 that is structurally formed in a manner that is configured to rupture upon reaching a critical temperature. As the critical temperature is indicative of a potential thermal event, the rupturing of the predetermined fracture location 22 allows an expulsion of the fire suppressant 20 from the tubular container 18 and into the engine compartment 14 of the transport refrigeration unit 10. A perforated or otherwise weakened portion of the tubular container 18 forms the predetermined fracture location 22. The material of the tubular container 18 and the structural detail of the predetermined fracture location 22 impact the critical temperature, such that the fire suppression system 16 may be tailored to different predetermined critical temperatures.

In some embodiments, the predetermined fracture location 22 is a single point or a plurality of points located along the tubular container 18. Alternatively, the predetermined fracture location 22 is an elongated fracture line (e.g., a seam) extending along a longitudinal direction of the tubular container 18. In such embodiments, the elongated fracture line may extend along simply a portion of the tubular container 18, along a majority of the tubular container 18, or along substantially the entire length of the tubular container 18.

To assist with expulsion of the fire suppressant 20 from the tubular container 18 and with dispersal of the fire suppressant 20 throughout the engine compartment 14, the tubular container 18 is pressurized in some embodiments. In one embodiment, the tubular container 18 is pressurized to a range of about 3 psia to about 5 psia. In a pressurized embodiment, the fire suppressant 20 is prone to more rapid and forceful expulsion from the tubular container 18 through the predetermined fracture location 22, thereby leading to a more complete and rapid dispersal through the engine compartment 14.

In some embodiments, the tubular container is disposed in contact and on top of another structure, such as a screen grate. Alternatively, in some other embodiments the tubular container 18 is in the form of a pouch that is freely suspended from an upper frame that may be fixed to any of the structural locations discussed above or any others contemplated. By suspending the pouch in an unsupported manner, opening of the predetermined fracture location 22 is not inhibited in any manner during a thermal event, thereby increasing a powder drop rate.

Advantageously, an on-board fire suppression system is provided for the transport refrigeration unit 10. The fire suppression system 16 passively releases the fire suppressant 20 in the event of an on-board thermal event. The predetermined fracture location 22 is configured to be opened or “unzipped” to disperse the fire suppressant 20. As the fire suppressant 20 is located in the immediate vicinity of the engine compartment 14, a thermal event is quickly and efficiently addressed by the fire suppression system 16.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A fire suppression system comprising:
a transport refrigeration unit configured to cool a transport container;
a tubular container having a fire suppressant stored therein, the tubular container disposed within the transport refrigeration unit; and
a predetermined fracture location of the tubular container, wherein the predetermined fracture location is configured to rupture upon reaching a critical temperature to expel the fire suppressant.

2. The fire suppression system of claim 1, wherein the tubular container comprises a plastic material.

3. The fire suppression system of claim 1, wherein the predetermined fracture location comprises an elongated fracture line extending along a longitudinal direction of the tubular container.

4. The fire suppression system of claim 3, wherein the elongated fracture line extends along a majority of the tubular container along the longitudinal direction.

5. The fire suppression system of claim 1, wherein the tubular container comprises a plurality of predetermined fracture locations configured to rupture upon reaching the critical temperature to expel the fire suppressant.

6. The fire suppression system of claim 5, wherein the plurality of predetermined fracture locations are each located adjacent components of an engine compartment of the transport refrigeration unit susceptible to a thermal event.

7. The fire suppression system of claim 6, wherein the thermal event comprises at least one of an electrical fire, a grease fire, flammable metal fire and a fuel fire.

8. The fire suppression system of claim 1, wherein the fire suppressant comprises at least one of mono-ammonium phosphate powder, potassium carbonate-based powder, sodium bicarbonate-based powder, and potassium allophanate, sodium chloride, copper powder, graphite, sodium carbonate, and sand.

9. The fire suppression system of claim 1, wherein the tubular container is located proximate an upper portion of an engine compartment of the transport refrigeration unit.

10. The fire suppression system of claim 1, wherein the tubular container is pressurized.

11. The fire suppression system of claim 10, wherein the tubular container is pressurized to a pressure ranging from 3 psia to 5 psia.

12. A method of suppressing a fire within a refrigeration transport unit comprising:
providing a predetermined fracture location along a portion of a tubular container configured to contain a fire suppressant therein;
positioning the tubular container proximate an engine compartment of the refrigeration transport unit;
rupturing the tubular container along the predetermined fracture location upon detection of a critical temperature within the engine compartment; and
expelling the fire suppressant from the tubular container.

13. The method of claim 12, wherein providing the predetermined fracture location comprises perforating the tubular container along a longitudinal direction of the tubular container.

14. The method of claim 12, wherein the fire suppressant configured to be contained comprises at least one of mono-ammonium phosphate powder, potassium carbonate-based powder, sodium bicarbonate-based powder, potassium allophanate, sodium chloride, copper powder, graphite, sodium carbonate, and sand.

15. The method of claim 12, wherein positioning the tubular container comprises positioning the tubular container proximate an upper portion of the engine compartment.

16. The method of claim 12, further comprising pressurizing the tubular container.
